(19) United States
(12) Patent Application Publication
(10) Pub. No.: US 2016/0188102 A1
(43) Pub. Date: Jun. 30, 2016

(54) METHOD FOR A TOUCH PANEL TO GENERATE A TOUCH SIGNAL

(71) Applicant: AU Optronics Corp., Hsin-Chu (TW)

(72) Inventors: Yi-Min Li, Hsin-Chu (TW); Sheng-Yun Chang, Hsin-Chu (TW); Sin-Guo Jhou, Hsin-Chu (TW); Yu-Min Hsu, Hsin-Chu (TW)

(21) Appl. No.: 15/060,563

(22) Filed: Mar. 3, 2016

Related U.S. Application Data
(63) Continuation of application No. 13/570,259, filed on Aug. 9, 2012.

(30) Foreign Application Priority Data
Apr. 27, 2012 (TW) 101115028

(51) Int. Cl. G06F 3/041

(52) U.S. Cl. CPC G06F 3/0416

(57) ABSTRACT

A touch panel includes a plurality of columns of sensing partitions, a plurality of driving lines, a plurality of sensing lines and a memory. A method for the touch panel to generate a touch signal includes sequentially inputting driving signals to the plurality of driving lines, reading a plurality of voltage values of one of the plurality columns of sensing partitions through one of the plurality of sensing lines, converting the plurality of voltage values into a plurality of digital values, calculating a mean of the digital values, and storing the coordinate of at least one digital value in a memory. The difference between the at least one digital value and the mean is larger than a predetermined value.

### CROSS REFERENCE TO RELATED APPLICATIONS

This is a Continuation of U.S. patent application Ser. No. 13/570,259, filed Aug. 9, 2012, which claims priority to Taiwan Patent Application No. 101115028, filed Apr. 27, 2012 and now Taiwan Patent No. 1464660, the contents of both U.S. patent application Ser. No. 13/570,259 and Taiwan Patent Application No. 101115028 are incorporated herein by reference in their entirety.

### BACKGROUND OF THE INVENTION

1. Field of the Invention

The present invention relates to a method for a touch panel to generate a touch signal, especially relating to a method for a touch panel to filter noise generated when a large area of the touch panel is pressed.

2. Description of the Prior Art

Liquid crystal displays (LCDs) are widely used nowadays for having slim shapes, low power dissipation and low radiation. LCDs gradually replaced traditional CRT (cathode ray tube) monitors and are widely applied on mobile electronic devices such as notebooks and PDAs (personal digital assistants). Further, using LCDs as input interfaces to perform sensing of touch inputs is popular. Displays having touch sensing functionality are applied on more and more electronic devices as input interfaces.

Touch panels are also applied on cell phones, tablets and personal computers to increase the flexibility of operation. Moreover, after using touch panels as input interfaces, keyboards and mouse devices are no longer needed, thus saving the space to configure the keyboards and mouse devices.

Touch panels can be classified as resistive type and capacitive type touch panels. Comparing with resistive type touch panels, capacitive type touch panels have advantages of sensing multiple touch inputs, thus gradually replacing resistive type touch panels. However, when a user presses a large area of a capacitive type touch panel, some partitions near the pressed area may sense capacitance due to the noise generated from the pressed area, though those partitions are not actually pressed. After capacitance is sensed on those partitions, the touch panel will judge those partitions as being pressed, and generate touch input commands accordingly. Thus, prior art capacitive type touch panels easily incorrectly judge the press condition of panels.

### SUMMARY OF THE INVENTION

An embodiment of the present invention provides a method for a touch panel to generate touch signals. The touch panel includes a plurality of columns of sensing partitions, a plurality of driving lines, a plurality of sensing lines and a memory. The method includes sequentially inputting driving signals to the plurality of driving lines, reading a plurality of first voltage values of one of the plurality columns of sensing partitions through one of the plurality of sensing lines, converting the plurality of first voltage values into a plurality of first digital values, calculating a first mean of the first digital values, and storing the coordinate of at least one first digital value larger than the first mean for a predetermined value in the memory.

The embodiments of the present invention are capable of filtering the touch signals belonging to noise generated due to a large area being pressed through the sensing lines sequentially scanning each column of sensing partitions to detect the voltage value of the columns of sensing partitions, and storing the coordinates of the substantially touched sensing partitions in the memory, and generating touch signals accordingly. Therefore, when performing large area pressing to the touch panel of the present invention, the touch panel will not misjudge the area not being pressed near the pressed area as being pressed, thus improving the accuracy of operation.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 shows a touch panel of the present invention.

FIG. 2 is a flowchart showing the touch panel of the present invention generating touch signals according to an embodiment of the present invention.

FIG. 3 shows the touch panel using the method in FIG. 2 to sense touched positions.

### DETAILED DESCRIPTION

Some phrases are referring to specific elements in the present specification and claims, please notice that the manufacturer might use different terms to refer to the same elements. However, the definition between elements is based on their functions instead of their names. Further, in the present specification and claims, the term “comprising” is open type and should not be viewed as the term “consisted of.” Besides, the term “electrically coupled” can be referring to either direct connection or indirect connection between elements.

Embodiments of the touch panels of the present invention are provided as follows. However, the claimed scope of the present invention is not limited by the provided embodiments.

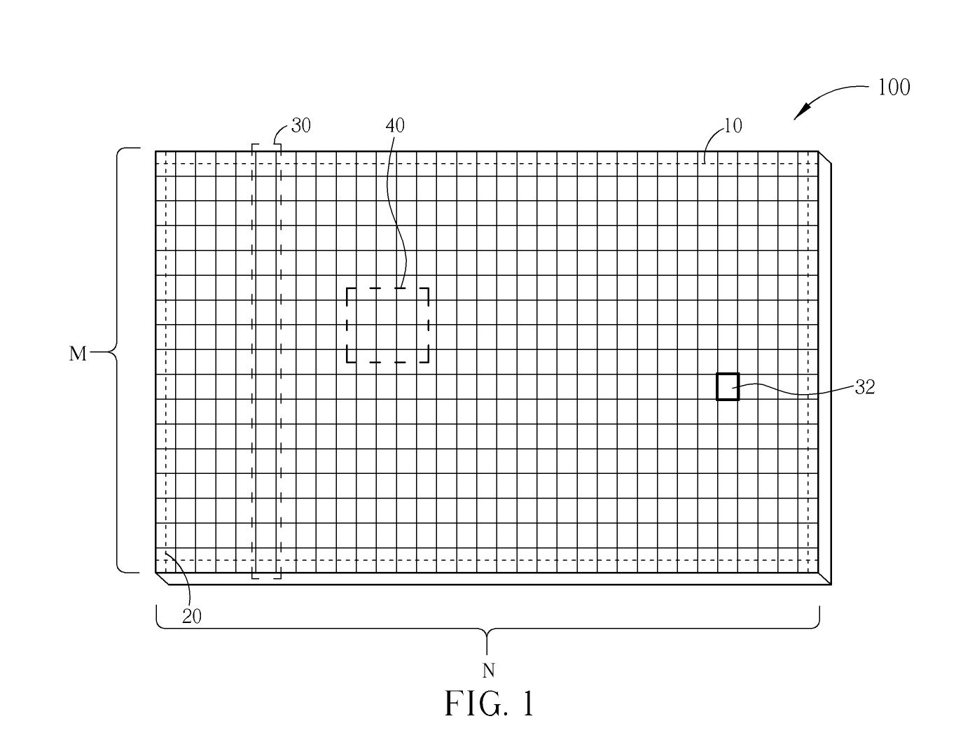

Please refer to FIG. 1, which shows a touch panel 100 of the present invention. The touch panel 100 includes N columns of sensing partitions 30, M driving lines 10, N sensing lines and 20 a memory 40. The driving line 10 is used to provide required driving voltages to drive the touch panel 100. Each sensing line 20 is used to sense touch signals corresponding to various positions of the touch panel 100, and the memory 40 is used to store data. Each column of sensing partition 30 includes M sensing partitions 32. N and M are both positive integers.

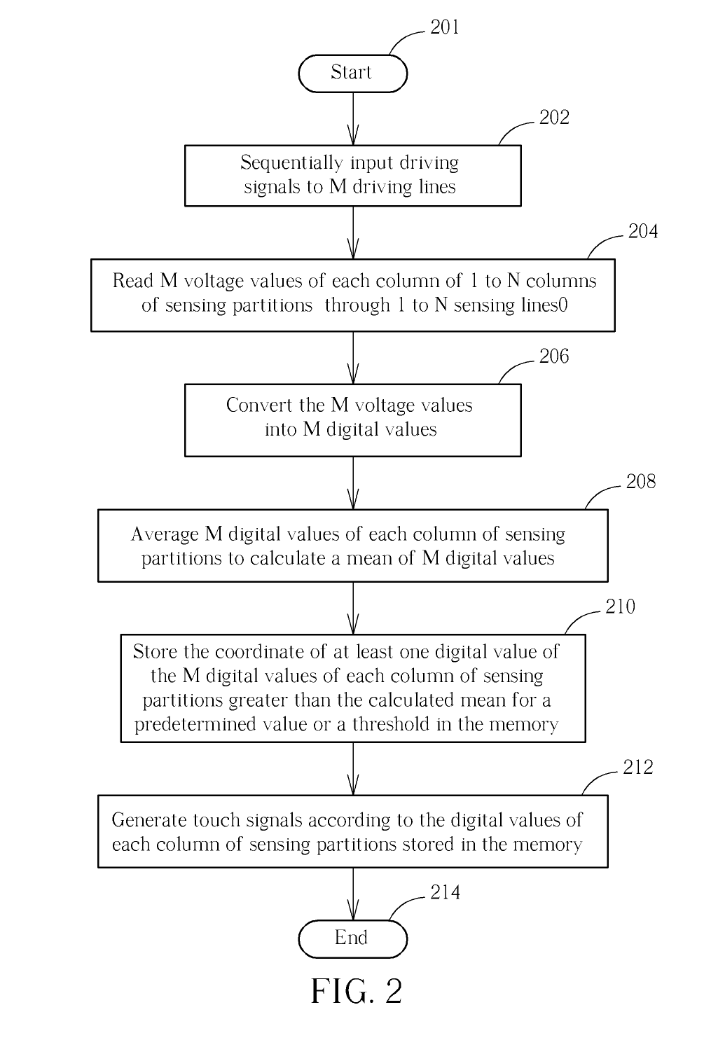

Please refer to FIG. 2 that is a flowchart showing the touch panel of the present invention generating touch signals according to an embodiment of the present invention. The descriptions are as follows.

Step 201: start;

Step 202: sequentially input driving signals to M driving lines 10;

Step 204: read M voltage values of each column of 1 to N columns of sensing partitions 30 through 1 to N sensing lines 20;

Step 206: convert the M voltage values into M digital values;

Step 208: average M digital values of each column of sensing partitions 30 to calculate a mean of M digital values;

Step 210: store the coordinate of at least one digital value of the M digital values of each column of sensing partitions 30 larger than the calculated mean for a predetermined value or a threshold in the memory 40;

Step 212: generate touch signals according to the digital values of each column of sensing partitions 30 stored in the memory 40;

Step 214: end.

In the steps 202 and 204, when inputting the driving signals to a first row driving line 10, the N sensing lines 20 will correspondingly read the voltage value of a first row sensing partition 32 of the N column of sensing partitions 30, and then when inputting the driving signals to a second row driving line 10, the N sensing lines 20 will correspondingly read the voltage value of a second row sensing partition 32 of the N column of sensing partitions 30, and the rest may be deduced by analogy. Thus, when inputting the driving signals to a last row driving line 10, the N sensing lines 20 will correspondingly read the voltage values of a last row sensing partition 32 of the N column of sensing partitions 30, and after sequentially inputting driving signals to M driving lines 10, all the sensing partitions 32 of each column of sensing partitions 30 are read. That is, the sensing partitions 32 of the entire touch panel 100 are read. The M voltage values corresponding to each column of sensing partitions 30 are converted into M digital values in Step 206, and the M digital values are averaged to generate a mean of M digital values as shown in Formula (1):

$${D}_{average} = \frac{{\sum }_{i = 1}^{M} {D}_{i}}{M} \qquad ( 1 )$$

In Formula (1), Dᵢ denotes the ith digital value corresponding to a column of sensing partition of the N columns of sensing partitions 30, and D_{average} denotes the mean of digital values corresponding to a column of sensing partition of the N columns of sensing partitions 30.

In Step 210, the digital values of the M sensing partitions 32 in each column of the sensing partitions 30 are respectively compared with the mean of digital values of the column of sensing partitions 30, to store the coordinate of at least one digital value of the M digital values of each column of sensing partitions 30 larger than the calculated mean for a predetermined value or a threshold in the memory 40, thus the coordinates stored in the memory 40 will be determined as the coordinates of the touched sensing partitions 32. After that, performing Steps 202 to 212 again to sense the following coordinates of the sensing partitions 32 of the touch panel 100. Besides, the touch panel 100 can further store the difference between the coordinate of at least one digital value of the M digital values of each column of sensing partitions 30 larger than the calculated mean for a predetermined value and the mean of digital values in the memory 40.

Moreover, after performing Steps 201 to 214 to the current frame, performs Steps 201 to 214 again to the next frame. For example, driving signals are sequentially inputted to M driving lines 10 again, and then M voltage values of each column of 1 to N columns of sensing partitions 30 through 1 to N sensing lines 20 are read, the rest may be deduced by analogy and will not further be illustrated.

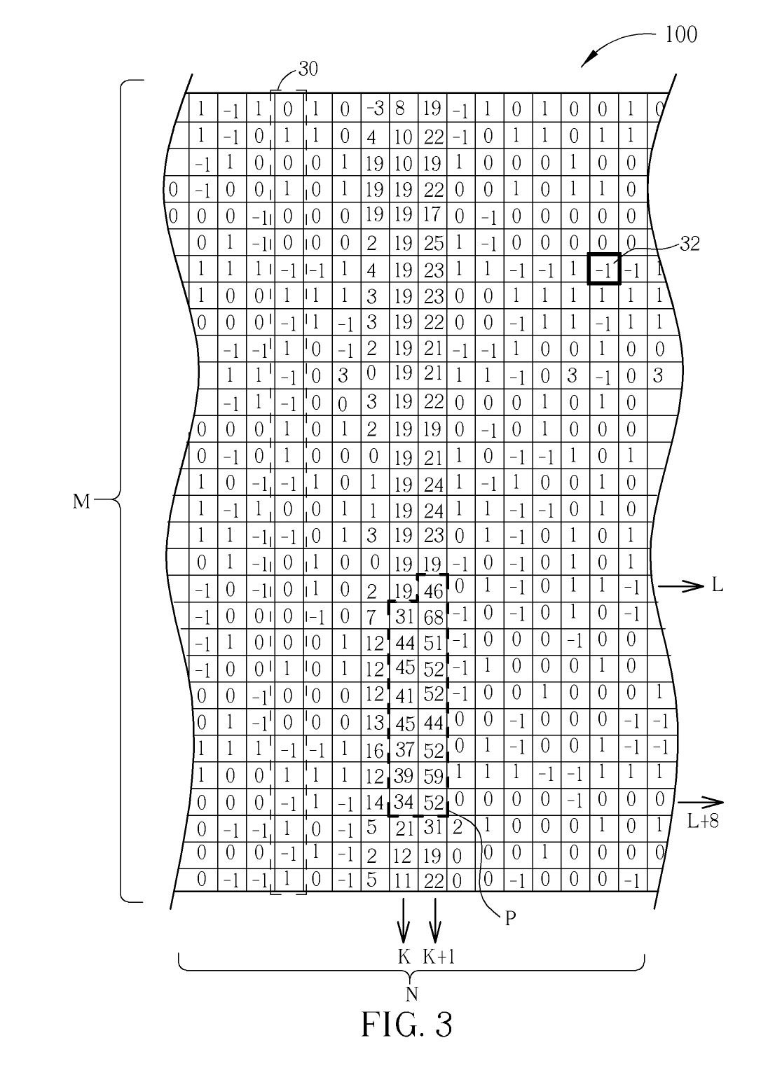

Please refer to FIG. 3, FIG. 3 shows the touch panel 100 in FIG. 2 sensing touched positions. As shown in FIG. 3, the touch panel 100 includes M×N sensing partitions. The dashed line region P denotes a region substantially touched by fingers of a user. After the user's fingers touch a plurality of sensing partitions 32 in the dashed line region P, the digital values generated in each sensing partition 32 are marked in the sensing partition 32. Compared with other sensing partitions, the entire K and Kth column of sensing partitions 30 generate larger digital values. However, in the K and Kth column of sensing partitions 30, the dashed line region P is the only region substantially being touched, the digital values marked in the sensing partitions other than the dashed line region P are generated due to the noise generated by a large area touch. For example, if the average digital value of the Kth column of sensing partitions 30 is 23.06, and the average digital value of the (K+1)th column of sensing partitions 30 is 31.92, and the threshold is set to 11, the coordinates of the (L+1) to (L+8) sensing partitions 32 of the Kth column of sensing partitions 30 and the coordinates of the (L+1) to (L+8) sensing partitions 32 of the (K+1)th column of sensing partitions 30 will be stored in the memory 40. Because the other sensing partitions 32 in the Kth and (K+1) th columns of sensing partitions 30 are not larger than the respective mean of digital values for the Kth and (K+1)th columns of sensing partitions 30, the coordinates of the other sensing partitions 32 in the Kth and (K+1)th columns of sensing partitions 30 will not be stored in the memory 40. It can be seen from the example in FIG. 3 that the touch panel 100 can accurately determine the dashed line region P is substantially touched by the user, instead of misjudging the entire Kth and (K+1)th columns of sensing partitions are touched by the user.

In general, after performing touch input to the touch panel, the touch panel will generate non-directly-touched signals corresponding to some parts of the touch panel not being touched, and those non-directly-touched signals can be viewed as noise. Though the non-directly-touched signals are smaller than the touch signals corresponding to some parts of the touch panel being substantially touched, the signal strengths of the non-directly-touched signals are still large enough to be sensed by the touch panel and to be misjudged as are some parts of the touch panel are directly touched. Thus prior art touch panels easily misjudge the touch condition. On the contrary, in the embodiments of the present invention, through comparing the digital value of each sensing partition in each column of sensing partitions with the mean of digital values of each column of sensing partitions and with the predetermined value, the touch signals belonging to non-directly-touched signals in the touch panel 100 can be filtered. Thus, when performing touch input to the touch panel 100, touch signals will be generated only according to the substantially touched parts of the touch panel 100.

In view of above, the embodiments of the present invention are capable of filtering the touch signals belonging to noise generated due to large area pressing through the sensing lines 20 sequentially scanning each column of sensing partitions 30 to detect the voltage values of the columns of sensing partitions 30, and storing the coordinate of the substantially touched sensing partitions 32 in the memory 40, and generating touch signals accordingly. Therefore, when performing large area pressing to the touch panel 100 of the present invention, the touch panel 100 will not misjudge the press condition of the area not being pressed near the pressed area as being pressed, thus improving the accuracy of operation.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for a touch panel generating touch signals, the touch panel comprising a plurality of columns of M sensing partitions, a plurality of driving lines, a plurality of sensing lines and a memory, the method for each column of M sensing partitions comprising:
sequentially inputting driving signals to the plurality of driving lines;
reading a first voltage value of each of the M sensing partitions in said each column to generate M first voltage values;
converting the M first voltage values into M first digital values;
averaging the M digital values to determine a first mean of the M first digital values; and
storing the coordinate of at least one first digital value larger than the first mean for a predetermined value in the memory only when the first mean is larger than a threshold set higher than first voltage values of the plurality of columns large enough to be sensed by the touch panel as a touch;
wherein M is greater than 1 and the first mean is averaged according to the M sensing partitions in each column when an input is present.

2. The method of claim 1, further comprising storing a difference between the at least one digital value and the first mean in the memory.

3. The method of claim 1, further comprising generating a touch signal according to the coordinate of the at least one first digital value.

4. The method of claim 1, wherein converting the M first voltage values into the M first digital values, is using an analog-to-digital converter to convert the M first voltage values into the M first digital values.

5. The method of claim 1, further comprising if the sensing line is not a last sensing line, performing the following steps:
reading a plurality of second voltage values of a next column of sensing partitions of the plurality columns of sensing partitions through a next sensing line of the plurality of sensing lines;
converting the plurality of second voltage values into a plurality of second digital values;
calculating a second mean of the second digital values; and
storing the coordinate of at least one second digital value larger than the second mean for the predetermined value in the memory;
wherein the first mean and second mean are determined respectively according to the specific corresponding column.

6. The method of claim 5, wherein the touch panel comprises n columns of sensing partitions and n sensing lines, a sensing line of the n sensing lines is a sensing line among a first sensing line to an (n−1) th sensing line of the n sensing lines, and a next sensing line of the n sensing lines is a sensing line among a second sensing line to an nth sensing line of the n sensing lines.

7. The method of claim 5, further comprising storing the difference between the at least one second digital value and the second mean in the memory.

8. The method of claim 5, further comprising generating a touch signal according to the difference between the at least one first digital value and the first mean.

9. The method of claim 5, wherein converting the plurality of second voltage values into the plurality of second digital values is using an analog-to-digital converter to convert the plurality of second voltage values into the plurality of second digital values.

10. The method of claim 1, further comprising if the sensing line is a last sensing line of the plurality of sensing lines, sequentially inputting the driving signals to the plurality of driving lines.

11. The method of claim 10, wherein the touch panel comprises n columns of sensing partitions and n sensing lines, a last sensing line of then sensing lines is an nth sensing line, the method further comprises reading a plurality of third voltage values of a first column of sensing partition of the n columns of sensing partitions through a first sensing line of the n sensing lines, where n is a positive integer.

12. A method for a touch panel generating touch signals, the touch panel comprising a plurality of columns of M sensing partitions, a plurality of driving lines, a plurality of sensing lines and a memory, the method comprising:
sequentially inputting driving signals to the plurality of driving lines;
reading a first voltage value of each of the M sensing partitions in a first column of the plurality of columns through one of the plurality of sensing lines to generate M first voltage values;
converting the M first voltage values into M first digital values;
averaging the M first digital values to determine a first mean of the M first digital values corresponding to the first column; and
storing the coordinate of at least one first digital value in the first column larger than the first mean for a predetermined value in the memory only when the first mean is larger than a predetermined threshold set higher than first voltage values of the plurality of columns large enough to be sensed by the touch panel as a touch
wherein M is greater than 1 and the first mean is averaged according to the M sensing partitions in the first column when an input is present.

13. The method of claim 12, further comprising if the sensing line is not a last sensing line, performing the following steps:
reading a plurality of second voltage values of a next column of sensing partitions of the plurality columns of sensing partitions through a next sensing line of the plurality of sensing lines;
converting the plurality of second voltage values into a plurality of second digital values;
calculating a second mean of the second digital values; and
storing the coordinate of at least one second digital value larger than the second mean for the predetermined value in the memory;
wherein the first mean and second mean are determined respectively according to the specific corresponding column.

14. The method of claim 13, wherein the touch panel comprises n columns of sensing partitions and n sensing lines, a sensing line of the n sensing lines is a sensing line among a first sensing line to an (n−1) th sensing line of the n sensing lines, and a next sensing line of the n sensing lines is a sensing line among a second sensing line to an nth sensing line of the n sensing lines.

15. The method of claim 13, further comprising storing the difference between the at least one second digital value and the second mean in the memory.

16. A method for a touch panel generating touch signals, the touch panel comprising a plurality of columns of each having M sensing partitions, a plurality of driving lines, a plurality of sensing lines and a memory, the method comprising performing the following steps column by column for the plurality of columns of M sensing partitions:
sequentially inputting driving signals to the plurality of driving lines;
reading voltage values of each of the M sensing partitions in a current column of sensing partitions through one of the plurality of sensing lines to generate M voltage values;
converting the M voltage values into M digital values for the current column;
averaging the M digital values for the current column to determine a mean of the M digital values for the current column; and
storing the coordinate of at least one digital value in the current column larger than the mean of the M digital values for the current column for a predetermined value in the memory only when the mean of the M digital values for the current column is larger than a threshold set higher than first voltage values of the plurality of columns large enough to be sensed by the touch panel as a touch;
wherein M is greater than 1 and the M digital values for the current column are averaged to generate the mean in each column when an input is present.

17. The method of claim 16, further comprising generating a touch signal according to the coordinate of the at least one digital value.

18. The method of claim 16, further comprising if the sensing line is not a last sensing line, performing the following steps:
reading M new voltage values of a next column of M sensing partitions of the plurality columns of M sensing partitions through a next sensing line of the plurality of sensing lines;
converting the M new voltage values into M new digital values;
calculating a new mean of the M new digital values; and
storing the coordinate of at least one new digital value larger than the new mean for the predetermined value in the memory;
wherein the mean and new mean are determined respectively according to the specific corresponding column.

19. The method of claim 18, wherein the touch panel comprises n columns of sensing partitions and n sensing lines, a sensing line of the n sensing lines is a sensing line among a first sensing line to an (n−1) th sensing line of the n sensing lines, and a next sensing line of the n sensing lines is a sensing line among a second sensing line to an nth sensing line of the n sensing lines.
